(19) United States
(12) Patent Application Publication
(10) Pub. No.: US 2016/0248230 A1
(43) Pub. Date: Aug. 25, 2016

(54) MODULAR POWER PLANT ASSEMBLY

(71) Applicant: Solar Turbines Incorporated, San Diego, CA (US)

(72) Inventors: Dalia El Tawy, San Diego, CA (US); Anthony R. Stimus, Spring Valley, CA (US); Steffen Thompson, San Diego, CA (US); SCOTT RANGE, CARLSBAD, CA (US); James R. Hickle, Ramona, CA (US); Varadharajan Sampathkumar, San Diego, CA (US); Silvio Cafaro, Como (IT); Fabrizio Longhi, Lecco (IT); Roberto Giarda, Verbania (IT); Gerlando Sorce, Viganello (IT)

(73) Assignee: Solar Turbines Incorporated, San Diego, CA (US)

(21) Appl. No.: 15/141,490

(22) Filed: Apr. 28, 2016

(51) Int. Cl. H02B 1/04; F01D 15/10

(52) U.S. Cl. CPC H02B 1/04; F01D 15/10

(57) ABSTRACT

A modular power plant assembly for distributed power generation includes a power generator assembly, to generate electrical power, mounted on a trailer. An AC/DC distribution panel electrically coupled to the power generator assembly is mounted on the power generator assembly. A Medium Voltage module electrically coupled to the power generator assembly is mounted on the trailer. The AC/DC distribution panel and the Medium Voltage module together control and distribute the electrical power generated by the power generator assembly. A plurality of auxiliary components to supply fuel and air to the power generator assembly are mounted adjacent to the power generator assembly on a skid attached to the trailer.

### TECHNICAL FIELD

The present disclosure relates to a modular power plant assembly. More specifically, the present disclosure relates to a modular power plant assembly for distributed power generation.

### BACKGROUND

Generally, in remote locations and/or developing regions, such as rural areas, oil and gas installations, research stations, dam installations, and so on, utilities such as electricity may be limited or non-existent. In such regions, providing a dedicated electrical network may not be feasible and cost efficient mainly due to remoteness of such regions to the nearest power generation facility or power grid, level of demand, and/or demand inconsistency. In such situations, modular power plants are generally used to meet the limited and/or varying demand of electricity of such regions. The modular power plants are readily transportable and may be installed at any location based on the demand.

U.S. Pat. No. 8,816,518 describes a containerized electrical substation module. The module includes an international Organization for Standardization (ISO) 40-foot-high cube substation container. The container includes a first transformer positioned at a first end of the substation container and a second transformer positioned at a second end of the substation container. The first and second transformers are electrically connected to a number of electric generator modules. The electric generator modules are contained in separate shipping containers that are separate from and external to the substation container. The electrical substation module is configured to generate 8MVA of apparent power that is 4MVA each from the first and second transformers.

However, the modular power plants may include a number of modules such as a generator, a transformer, switchgear, and/or other related control systems which have to be placed on separate shipping containers for transportation. Due to the number and complexity of these modules, the modular power plants may require high transportation cost, high installation cost, high installation time, and significant installation expertise. Also, such modular power plants may not be scalable for supporting future capacity expansion. Hence, there is a need for an improved modular power plant assembly.

### SUMMARY OF THE DISCLOSURE

In an aspect of the present disclosure, a modular power plant assembly for distributed power generation is provided. The power plant assembly includes a power generator assembly for generating electrical power mounted on a trailer An Alternating Current/Direct Current (AC/DC) distribution panel is electrically coupled to the power generator assembly. The AC/DC distribution panel is mounted on the power generator assembly. The power plant assembly further includes a Medium Voltage module electrically coupled to the power generator assembly. The Medium Voltage module is mounted on the trailer. The AC/DC distribution panel and the Medium Voltage module together control and distribute the electrical power generated by the power generator assembly. A plurality of auxiliary components for supplying fuel and air to the power generator assembly are mounted adjacent to the power generator assembly on a skid attached to an upper deck of the trailer.

### BRIEF DESCRIPTION OF THE DRAWINGS

FIG. 1 is a perspective view of a modular power plant assembly, in accordance with an embodiment of the present disclosure;

FIG. 2 is a perspective view of the modular power plant assembly provided with a housing, in accordance with an embodiment of the present disclosure;

FIG. 3 is a perspective view of the modular power plant assembly provided with a housing, in accordance with another embodiment of the present disclosure; and

FIG. 4 is a top view of the modular power plant assembly, in accordance with another embodiment of the present disclosure.

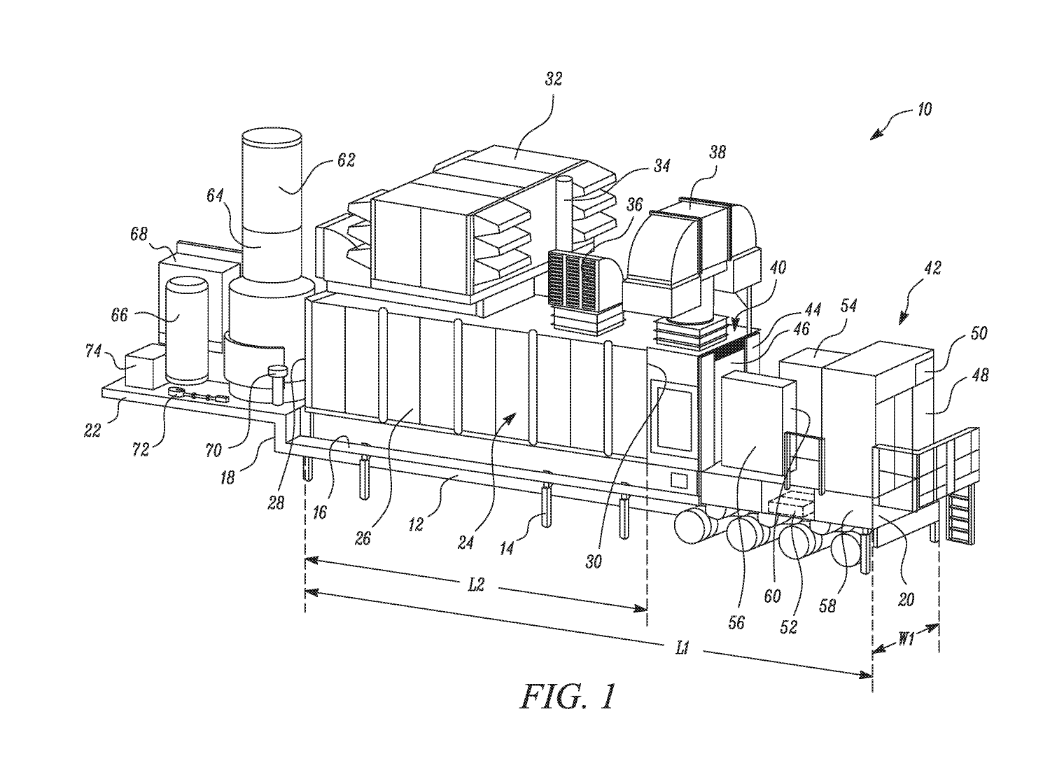

### DETAILED DESCRIPTION

Wherever possible, the same reference numbers will be used throughout the drawings to refer to same or like parts. Referring to FIG. 1, a Mobile Power Unit (MPU) 10 is shown. The MPU 10 includes various modules and subsystems arranged on a trailer 12. The trailer 12 may have multiple axles having wheels mounted on them. For example, the trailer 12 may have four axles. The trailer 12 includes multiple supporting legs 14 for supporting the trailer 12 while parked in a stationary condition on the ground, The trailer 12 further includes a trailer floor 16 on which the various modules and subsystems are mounted. The trailer 12 may include isolating pads (not shown) mounted on the trailer floor 16. The isolating pads may absorb the vibrations produced by the operation of various modules and subsystems mounted on the trailer floor 16. The trailer floor 16 has a first end 18 and a second end 20. As shown in the FIG. 1, a skid 22 is attached to the first end 18 of the trailer floor 16. In the illustrated embodiment, the trailer 12 has a length dimension L₁ of approximately 60 feet and a width dimension W₁ of approximately 8 feet providing a compact footprint to minimize space requirements. The length and width dimensions L₁, W₁ respectively of the trailer 12 may vary in accordance with the requirement and size of the various modules and subsystems to be mounted.

As shown in FIG. 1, the MPU 10 includes a power generator (PG) assembly 24. The PG assembly 24 includes a turbine (not shown) and a generator (not shown) packaged inside a housing 26 for generating electrical energy. A reduction gearbox (not shown) is included between the gas turbine and the generator to provide variable output power. The PG assembly 24 is mounted on the trailer floor 16 positioned at the first end 18 and extending lengthwise on the trailer 12 towards the second end 20. Isolation pads (not shown) may be attached to the bottom of the PG assembly 24 to absorb the vibrations produced due to an operation of the PG assembly 24. The PG assembly 24 extends from the first end 18 of the trailer 12 and ends partway in between before the second end 20 of the trailer 12. As shown in FIG. 1, the PG assembly 24 has a first end 28 and a second end 30. The first end 28 of the PG assembly 24 may coincide with the first end 18 of the trailer 12. The PG assembly 24 has a length dimension L₂ shorter than the length dimension L₁ of the trailer 12. The PG assembly 24 may have a width dimension W₂ (not shown) matching the width dimension W₁ of the trailer 12. The PG assembly 24 may cover whole area of the trailer floor 16 across the span of the length dimension L₂ starting from the first end 18 of the trailer 12. The PG assembly 24 further includes various auxiliary components mounted on top of the PG assembly 24 such as, but not limited to, a turbine air inlet filter 32, an oil mist eliminator 34, a generator ventilation outlet 36 and an inlet air filter 38 etc. Further, an Alternating. Current/Direct Current (AC/DC) distribution panel 40 and a Medium Voltage module 42 are also electrically coupled to the PG assembly 24.

The AC/DC distribution panel 40 includes multiple components inside a single cabinet 44. The AC/DC distribution panel 40 may include components such as, but not limited to, a Motor Control Center (MCC), a Variable Frequency Drive (VFD), a Ride Through Unit (RTU), and a battery charger. All of the aforementioned components provided inside the AC/DC distribution panel 40 are pre-designed and pre-assembled inside the cabinet 44. The components are tested before being assembled into the cabinet 44 so as to avoid any possibility of a failure while in operation The AC/DC distribution panel 40 may also include a door 46 in the cabinet 44 to access the various components for maintenance, repair or any other purposes. The AC/DC distribution panel 40 is mounted on the PG assembly 24 towards the second end 30 of the PG assembly 24. Isolating pads (not shown) may be attached between the PG assembly 24 and the AC/DC distribution panel 40 to absorb vibrations.

The Medium Voltage module 42 includes multiple components such as, but not limited to, a switchgear 48, a Neutral Ground Resistor (NGR) 50, a battery 52, a transformer 54 and a fire suppression unit 56. All the aforementioned components provided inside the Medium Voltage module 42 are pre-designed and pre-assembled. The components are tested before being assembled so as to avoid any possibility of a failure while in operation. The Medium Voltage module 42 is mounted on the trailer floor 16 towards the second end 20 of the trailer 12. The Medium Voltage module 42 includes a hollow base 58 mounted on the trailer floor 16 at the second end 20 of the trailer 12. Isolator pads (not shown) may be attached between the base 58 and the trailer floor 16 to absorb vibrations. The battery 52 is housed in the hollow base 58. The transformer 54 is placed adjacent to the PG assembly 24 over the base 58 and extends lengthwise towards the second end 20 of the trailer 12, The transformer 54 is a step down transformer. The fire suppression unit 56 is placed adjacent to the PG assembly 24 parallel to the transformer 54 over the base 58 and extends towards the second end 20 of the trailer 12. The fire suppression unit 56 may include Carbon Dioxide (CO₂) cylinders housed inside a cabinet 60. The switchgear 48 is placed adjacent to the transformer 54 and the fire suppression unit 56 at the second end 20 of the trailer 12 over the base 58. The NGR 50 is placed on top of the switchgear 48.

The AC/DC distribution panel 40 and the Medium Voltage module 42 together control and distribute the power generated by the PG assembly 24 with the assistance of various aforementioned components. The AC/DC distribution panel 40 and the Medium Voltage module 42 include various electrical connections. These electrical connections include connections between various electrical components included in the AC/DC distribution panel 40 and the Medium Voltage module 42 as well as the electrical connections with the PG assembly 24. The electrical connections are hardwired wherever possible. The electrical connections may also be plug and play connections. The plug and play connections allow flexibility of quickly engaging/disengaging various parts relative to each other. The power generated by the PG assembly 24 is distributed as per the requirement of the area where the MPU 10 is employed.

With continued reference to FIG. 1, the skid 22 attached to the first end 18 of the trailer 12 mounts multiple auxiliary components. The skid 22 mounts an exhaust silencer 62 and an exhaust stack 64. The exhaust stack 64 allows exhaust gases from the PG assembly 24 to be released in the atmosphere. The exhaust silencer 62 helps in lowering noise emission levels for the PG assembly 24. The skid 22 further mounts an air compressor 66, a lubricant cooler 68, a gas fuel filter 70, a gas fuel meter 72, and a liquid fuel filter 74. The air compressor 66 is mounted in a vertical configuration, as shown in FIG. 1, for saving space on the skid 22. However, in an embodiment, the air compressor 66 may also be mounted in a horizontal configuration on the skid 22. In order to create space for horizontal mounting of the air compressor 66, the lubricant cooler 68 may be placed on the ground surface with respect to the trailer 12. Apart from the components mentioned, the skid 22 may mount other components as well, so as to suit the need of the required application. As opposed to other subsystems of the MPU 10 such as the PG assembly 24, the AC/DC distribution panel 40 and the Medium Voltage module 42, the auxiliary components may not be packaged inside a housing or a cabinet.

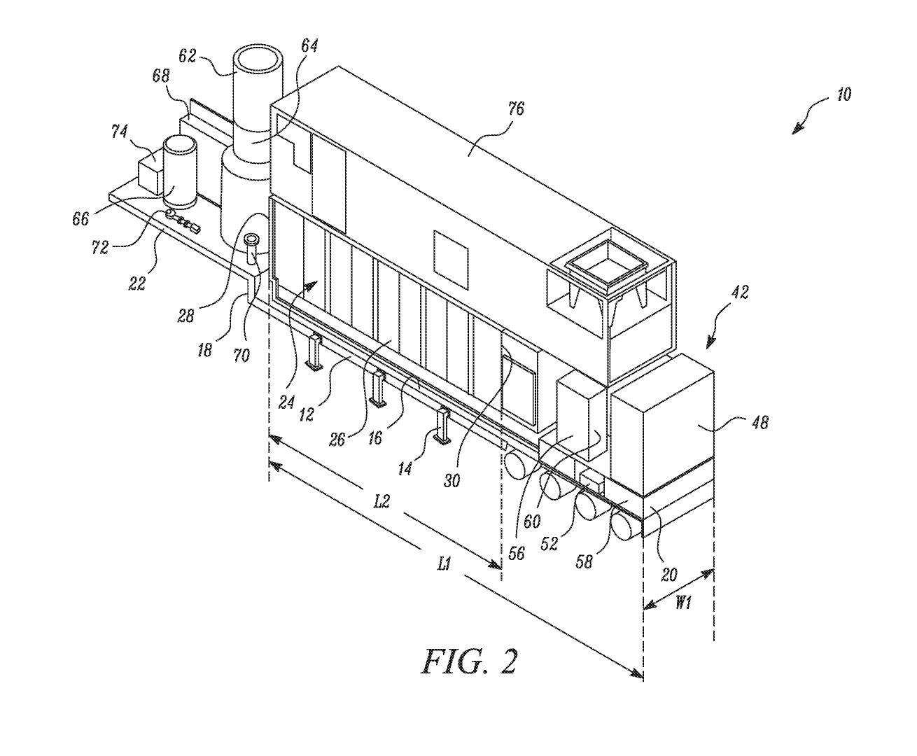

FIG. 2 shows another embodiment of the present disclosure. The MPU 10 is provided with a housing 76 on the top of the PG assembly 24 so that the various auxiliary components mounted on the top of the PG assembly 24 are covered within the housing 76. The housing 76 may be a rectangular housing of the same type as the housing 26 of the PG assembly 24. The housing 76 also includes pre-defined space for the auxiliary components mounted on the skid 22 except for the exhaust silencer 62 and the stack 64.

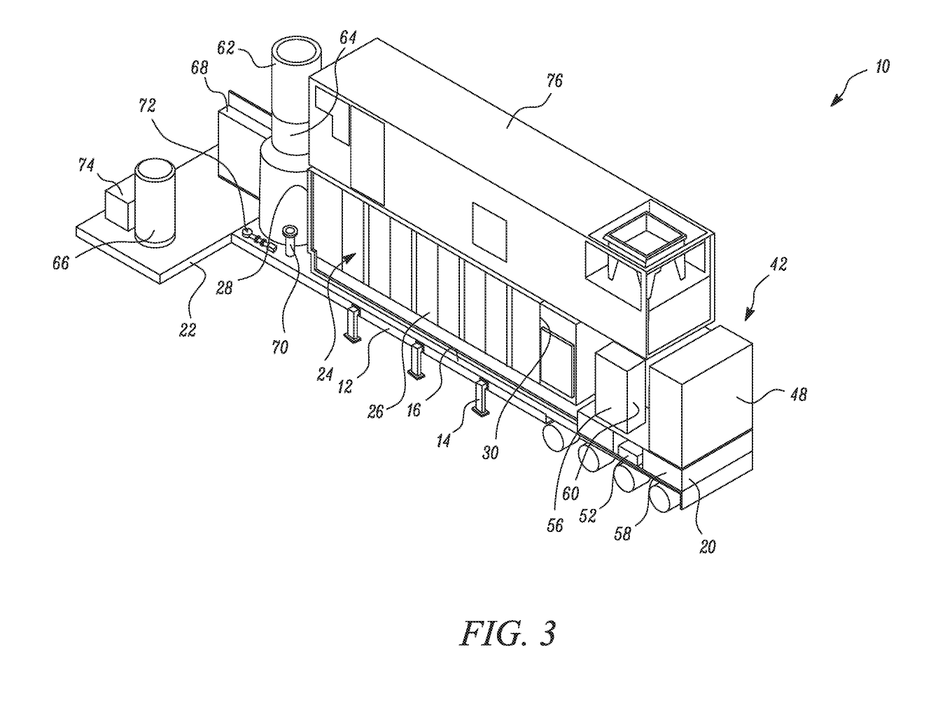

FIG. 3 illustrates another embodiment of the MPU 10. The exhaust silencer 62 and the exhaust stack 64 are integrated with the PG assembly 24. The exhaust silencer 62 and the exhaust stack 62 are placed on the trailer 12. The gas fuel filter 70 and the gas fuel meter 72 are also placed on the trailer 12 adjacent to the exhaust silencer 62 and the exhaust stack 64. Other auxiliary components may be placed on the skid 22. Alternatively, the other auxiliary components may be placed inside the housing 76.

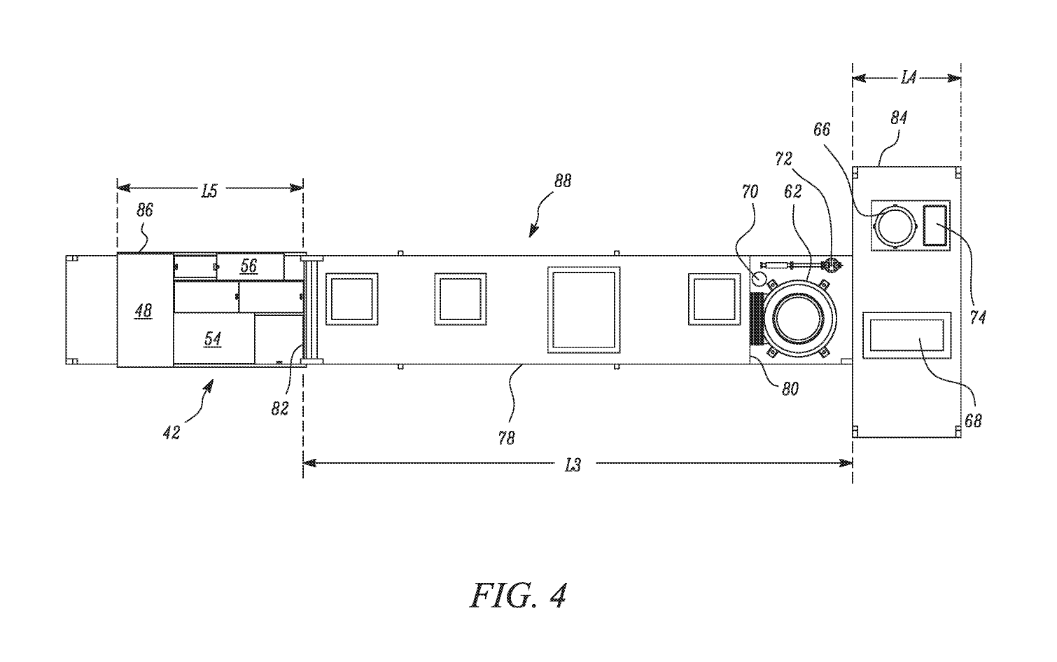

FIG. 4 shows another embodiment of the present disclosure. A flat container 78 is used to arrange the various subsystems and modules. In an embodiment of the present disclosure, the flat container 78 is a designated International Organization for Standardization (ISO) flat container. The flat container 78 may have a length dimension L₃ of approximately 40 feet. The PG assembly 24 is placed on the flat container 78. The PG 24 assembly may be connected to the flat container 78 with spring isolators or a mechanical connection. The flat container 78 has a first end 80 and a second end 82. The AC/DC distribution panel 40 is mounted on the PG assembly 24 towards the second end 82. The exhaust silencer 62 and the exhaust stack 64 are placed on the flat container 78 towards the first end 80 of the flat container 78. The exhaust silencer 62 and the exhaust stack 64 may be integrated with the PG assembly 24. The gas fuel filter 70 and the gas fuel meter 72 are also placed on the flat container 78. The gas fuel filter 70 and the gas fuel meter 72 may be placed adjacent to the exhaust silencer 62 and the exhaust stack 64 on the flat container 78. A first submodule 84 is attached to the flat container 78 at the first end 80 of the flat container 78. The first submodule 84 may be connected to the flat container 78 via a mechanical connection, The mechanical connection may be of any type including, but not limited to, a fastener, welding etc. The first submodule 84 mounts multiple auxiliary components. The auxiliary components include the air compressor 66, the lubricant cooler 68, and the liquid fuel filter 74. The first submodule 84 may also mount any other auxiliary component if required, according to the need of the application. In an embodiment, the first submodule 84 may have a length dimension L₄ of 20 feet. A second submodule 86 is attached to the flat container 78 at the second end 82 of the flat container 78.

The second submodule 86 may be connected to the flat container 78 via a mechanical connection similar to the connection between the first submodule 84 and the flat container 78. The second submodule 86 mounts the Medium Voltage module 42. The Medium Voltage module 42 includes the switchgear 48, the NGR 50, the battery 52, the transformer 54 and the fire suppression unit 56. These subsystems are arranged in the same manner relative to one another as arranged on the MPU 10. The components placed on the second submodule 86 may be electrically connected to the PG assembly 24 placed on the fiat container 78 via plug and play connections. In an embodiment, the second submodule 86 may have a length dimension L₅ of 20 feet.

The arrangement of various subsystems and modules arranged on a combination of the flat container 78 and the first and second submodules 84, 86 is called as a Modular Power Plant (MPP) 88. The MPP 88 offers ease of transportation and portability. The Out container 78 may be transported on any standard trailer or ISO Container Shipping Vessel etc. The first and second submodules 84, 86 may be separately transported than the flat container 78. After reaching the place of operation of the MPP 88, the first and second submodules 84, 86 may be readily attached to the flat container 78.

### INDUSTRIAL APPLICABILITY

Power generation plants are generally centralized and require electricity to be transmitted over long distances. However, there may still be locations that are classified as remote and it may not be possible to transmit the electricity generated by the conventional means to such locations. Distributed power generation methods are used to cater to power requirements of such locations. Distributed power generation refers to producing electricity near the end users by employing small scale technologies in an efficient and comparatively less expensive manner. Various methods are used for distributed power generation such as, but not limited to, solar power, wind power, hydropower, energy produced from waste-products etc. Another such method is to provide an easily transportable and readily installable MPU 10.

The MPU 10 provides a portable and readily transportable means of distributed power generation. The MPU 10 includes the PG assembly 24, the AC/DC distribution panel 40. the Medium Voltage module 42 and various other auxiliary components arranged on the trailer 12. The trailer 12 provides for flexibility in transportation of the MPU 10. The trailer 12 needs to be attached on a self-propelled vehicle such as a truck etc. and may be easily transported to the required location. The trailer 12 also provides mobility of the MPU 10 at a worksite. Further, the use of the spring isolators between the trailer 12 and the PG assembly 24 allows the MPU 10 to be installed on a wide variety of foundation types without being impacted by vibration of the foundation.

The MPU 10 also offers easy installation procedures. The MPU 10 includes various modules and subsystems which are pre-designed and pre-tested. Further, these modules include hardwired electrical connections wherever possible and provide for plug & play connections means. These types of packaging and connections make it easier to install the MPU 10 at the worksite. Generally, it may take less than a day to install the MPU 10 at the worksite in a configuration which is ready to produce the required power. The MPU 10 is a standalone and independent distributed power generation solution. The MPU 10 may not require any external support or attachment to the grid to generate power.

While aspects of the present disclosure have been particularly shown and described with reference to the embodiments above, it will be understood by those skilled in the art that various additional embodiments may be contemplated by the modification of the disclosed machines, systems and methods without departing from the spirit and scope of what is disclosed. Such embodiments should be understood to fall within the scope of the present disclosure as determined based upon the claims and any equivalents thereof.

What is claimed is:

1. A modular power plant assembly for distributed power generation, the assembly comprising:
a power generator assembly including at least a turbine and a generator configured to generate electrical power, the power generator assembly mounted on a trailer:
an Alternating Current/Direct Current (AC/DC) distribution panel electrically coupled to the power generator assembly, the AC/DC distribution panel mounted on the power generator assembly;
a Medium Voltage module electrically coupled to the power generator assembly, the Medium Voltage module mounted on the trailer, wherein the AC/DC distribution panel and the Medium Voltage module together configured to control and distribute the electrical power generated by the power generator assembly; and
a plurality of auxiliary components configured to supply fuel and air to the power generator assembly, the plurality of auxiliary components mounted adjacent to the power generator assembly on a skid attached to the trailer.

2. The modular power plant assembly of claim 1, wherein the plurality of auxiliary components includes at least an air compressor, a lubricant cooler, an exhaust silencer and an exhaust stack, a gas fuel filter, a gas fuel meter, and a liquid fuel filter.

3. The modular power plant assembly of claim 1, wherein the AC/DC distribution panel includes at least one of a Motor Control Center (MCC), a Variable Frequency Drive (VFD), a battery charger, and a Ride Through Unit (RTU).

4. The modular power plant assembly of claim 1, wherein the Medium Voltage module includes at least one of a switchgear. a Neutral Ground Resistor (NGR), a battery, a transformer and a tire suppression unit.

5. The modular power plant assembly of claim 1 further comprising one or more isolator pads mounted between a top surface of the trailer and a bottom surface of each of the power generator assembly, the AC/DC distribution panel and the Medium Voltage module.

6. The modular power plant assembly of claim 1, wherein the power generator assembly is electrically coupled to the AC/DC distributed panel and the Medium Voltage module through plug and play connections.
